(19) United States
(12) Patent Application Publication
(10) Pub. No.: US 2022/0411605 A1
(43) Pub. Date: Dec. 29, 2022

(54) Hydrolysis-resistant compositions comprising polyethylene terephthalate (PET)

(71) Applicant: LANXESS Deutschland GmbH, Cologne (DE)

(72) Inventors: Wilhelm Laufer, Ellerstadt (DE); Marcel Gelfort, Hockenheim (DE)

(73) Assignee: LANXESS Deutschland GmbH, Cologne (DE)

(21) Appl. No.: 17/715,220

(22) Filed: Apr. 7, 2022

Related U.S. Application Data
(63) Continuation of application No. 16/747,231, filed on Jan. 20, 2020, now abandoned.

(30) Foreign Application Priority Data
Jan. 23, 2019 (EP) 19153199.5

(51) Int. Cl. C08K 5/29; C08J 3/20

(52) U.S. Cl. CPC C08K 5/29; C08J 3/203; C08J 2367/02

(57) ABSTRACT

The invention relates to hydrolysis-resistant compositions comprising polyethylene terephthalate (PET), production processes, and use of the said compositions.

The invention relates to hydrolysis-resistant compositions comprising polyethylene terephthalate (PET), production processes, and use of the said compositions.

Polyethylene terephthalate (PET) is used for fibres, for moulding compositions for the production of plastics products such as drinks bottles, and also for the production of films, e.g. for electrical insulation and solar cells.

The water content of PET generally supplied by the manufacturer in granulate form for further processing is of the order of magnitude of 0.2 to 0.4% (2000 to 4000 ppm); the moisture content here and its distribution on the surface of the granulate and within the interior of the granulate depend on the crystallinity of the PET in the granulate, and on its composition.

Because the “natural” moisture content of a commercially available PET granulate leads to hydrolytic PET degradation during production of a PET melt, and this affects the quality of the final products obtained, the procedure for the production of high-quality PET products usually includes crystallization, by heating, of the moist PET granulate obtained from the manufacturer, followed by thorough drying. Particularly when biaxially stretched PET films are to be used as capacitor films, films for magnetic recording media, X-ray film substrates, or for graphic-arts applications, there is a requirement for films with excellent optical and mechanical properties together with high surface quality and high homogeneity. In order to achieve these properties, it is necessary to achieve maximum effectiveness in restricting hydrolytic degradation during processing.

PET is particularly susceptible to hydrolysis caused by moisture when it is molten at high temperatures. In contrast, finished products made of solid PET after solidification have almost no significant sensitivity to moisture. However, in order to prevent deterioration of fibre quality during service life of the textile manufactured therefrom, PET usually comprises, as additive, a hydrolysis stabilizer which in particular comprises carbodiimide groups and is generally polymeric. The polycarbodiimide compound is present in homogeneous dispersion in quantities of about 1 to 2.5% by weight in the finished PET fibre, and binds traces of water that penetrate into the fibre and that could lead to partial PET hydrolysis with gradual deterioration of quality. These hydrolysis stabilizers serve exclusively to improve the long-term stability of the finished PET products.

When polymeric carbodiimides are compared with monomeric carbodiimides, however, they have disadvantages because they are less reactive at relatively low temperatures and are difficult to disperse in the polymer matrix, requiring use of specialized technical equipment under relatively aggressive process conditions.

Some monomeric carbodiimides in turn have the disadvantage that many of them are per se toxic and are volatile at low temperatures. They are thermally unstable, and lead to increased emission of other volatile and toxic substances during processing; careful selection is therefore necessary.

EP-A 2671912 discloses use of monomeric aromatic carbodiimides as hydrolysis stabilizers in polymers such as polyethylene terephthalate (PET), polybutylene terephthalate (PBT), polytrimethylene terephthalate (PTT), thermoplastic polyurethanes (TPU), copolyesters, thermoplastic polyester elastomers (TPEE), polylactic acid (PLA) and/or PLA derivatives, or else polyhydroxyalkanoates (PHA).

However, here again PET has specifically proved to be, among the polymers, the polymer that is most difficult to stabilize in relation to hydrolysis with the result that even the carbodiimides disclosed in EP-A 2671912 become inadequate and there was a requirement for further optimization of the hydrolysis resistance of PET.

It was therefore an object of the present invention to provide improved hydrolysis-resistant polyethylene terephthalate (PET) compositions which do not have the abovementioned disadvantages, i.e. especially are not toxicologically hazardous.

Surprisingly, this object was achieved via use of particular monomeric carbodiimides when content of urea compounds therein, based on the carbodiimide is <1000 ppm, preferably <500 ppm.

The present invention provides a process for stabilizing polyethylene terephthalate (PET) in respect of hydrolysis, characterized in that at least one monomeric carbodiimide of the formula (I) is used,

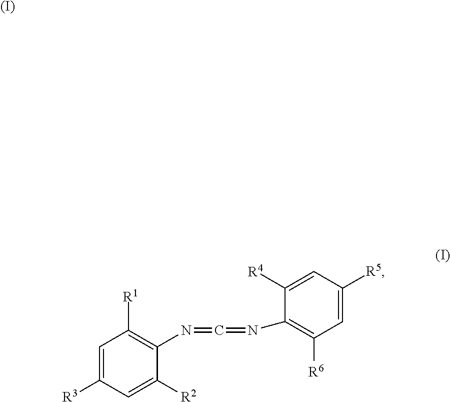

where
R¹, R², R⁴ and R⁶ are mutually independently C₃-C₆-alkyl and
R³, R⁵ are mutually independently C₁-C₃-alkyl,
having, based on the carbodiimide, less than 1000 ppm content, preferably less than 500 ppm content, particularly preferably less than 100 ppm content of urea compounds of the formulae (II) and (III)

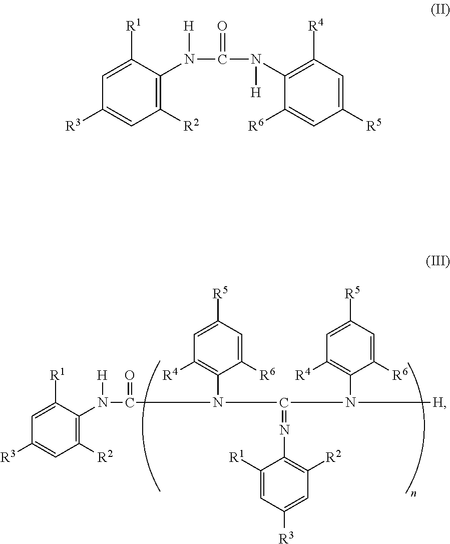

n is 1-100, preferably 1-50 and R¹ to R⁶ are as defined above.

The proportion of urea compounds of the formula (II) and (III) in the carbodiimides used according to the invention is <1000 ppm, preferably <500 ppm, particularly preferably <100 ppm, based on the carbodiimide.

The C₃-C₆-alkyl moieties of the carbodiimides used of the formula (I) can be linear and/or branched. They are preferably branched.

The moieties R¹ to R⁶ in the carbodiimides of the formula (I) used in the compositions of the invention are preferably identical.

In another preferred embodiment of the invention, the moieties R¹ to R⁶ are isopropyl. The NCN content of the carbodiimides used is preferably 8 to 10% by weight, with preferably 8 to 9% by weight.

These carbodiimides can preferably be produced via carbodiimidation of trisubstituted benzene isocyanates of the formula (IV)

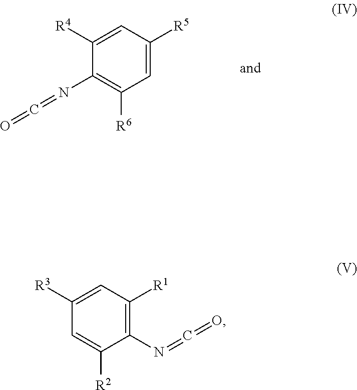

in which R¹, R², R⁴ and R⁶ are mutually independently C₃-C₆-alkyl
and R³ and R⁵ are mutually independently C₁-C₃-alkyl
at temperatures of 40° C. to 200° C. in the presence of catalysts and optionally solvents, with elimination of carbon dioxide.

The trisubstituted benzene isocyanates are preferably 2,4,6-triisopropylphenyl isocyanate, 2,6-diisopropyl-4-ethylphenyl isocyanate and 2,6-diisopropyl-4-methyl phenyl isocyanate. The trisubstituted benzene amines needed for producing the above compounds can—as is known to those skilled in the art—be prepared by Friedel-Crafts alkylation of aniline with the appropriate alkene, haloalkane, haloalkene benzene and/or halocycloalkane.

These compounds are then reacted with phosgene to give the corresponding trisubstituted benzene isocyanate.

The carbodiimidation is preferably effected by the processes described in Angew. Chem. 93, pp. 855-866 (1981) or DE-A-11 30 594 or Tetrahedron Letters 48 (2007), pp. 6002-6004.

In a preferred embodiment of the invention, preferred catalysts for producing the compounds of the formula (I) are strong bases or phosphorus compounds. Preference is given to use of phospholene oxides, phospholidines or phospholine oxides, and also the corresponding sulfides. The following can moreover be used as catalysts: tertiary amines, basic metal compounds, the oxides, hydroxides, alcoholates or phenolates of alkali metals or of alkaline earth metals, metal carboxylates and non-basic organometallic compounds.

The carbodiimidation can be carried out either without solvent or in a solvent. It is equally possible to begin the carbodiimidation without solvent and then to complete the same after addition of a solvent. Examples of solvents that can be used are petroleum spirits, benzene and/or alkylbenzenes.

It is also equally possible to produce the carbodiimides to be used in the process of the invention from the trisubstituted anilines via reaction with CS₂ to give the thiourea derivative followed by reaction in basic hypochlorite solution to give the carbodiimide, or by the process described in EP 0597382 A.

After production of the carbodiimides of the formula (I), these are preferably freed from urea compounds of the formula (II) and (III) in a manner such that content of these is at most 1000 ppm. This is preferably achieved by means of recrystallization in at least one solvent. Suitable purification solvents used are preferably alcohols, ketones, nitriles, ethers or esters. Particular preference is given to alcohols from the group of the aliphatic monoalcohols, preferably methanol, ethanol or isopropanol. In another preferred embodiment of the invention, mixtures of various solvents, preferably alcohols, are used. Particular preference is given here to mixtures of methanol with ethanol in a ratio of from 1:3 to 3:1, preferably 1:2 to 2:1, particularly preferably 1:1.

During the recrystallization, it is preferable that the carbodiimide is dissolved in at least one solvent at temperatures of 40-80° C., particularly preferably at 50-60° C., and stirred. The mixture is then cooled, with stirring, preferably to 10-25° C., particularly preferably to 15-20° C. The resultant crystals are then isolated by suction-filtration, or separated from the mother liquor. Filter presses, centrifuges, suction-filter funnels or pressure-filter funnels can be used for this purpose. The solid is then either dried in a drier—preferably paddle drier or drying oven—preferably under reduced pressure, and packed as solid, or charged to a stirred tank, preferably at 50-100° C., freed from residual solvent by distillation, and drawn off as liquid.

For the production of the composition made of polyethylene terephthalate (PET) and of the monomeric carbodiimide of the formula (I), it is preferable to use assemblies for solids-metering and mixing.

For the purposes of the invention, assemblies for solids-metering and mixing are: single-, twin- and multi-screw extruders, continuous co-kneaders (Buss-type) and batch kneaders, e.g. Banbury-type, and other assemblies conventionally used in the polymer industry.

The concentration of the carbodiimides of the formula (I) in polyethylene terephthalate (PET) is preferably 0.5-5% by weight, preferably 1.0-3% by weight, particularly preferably 1.5-2.5% by weight.

The polyethylene terephthalate (PET) for the purposes of the invention is preferably any of the polyethylene terephthalates that derive from terephthalic acid (or from its reactive derivatives) and from alkanediols based on ethylene glycol. This includes not only a single polyethylene terephthalate but also a mixture of two or more different polyethylene terephthalates.

Particular preference is given to polyethylene terephthalates produced solely from terephthalic acid and its reactive derivatives, e.g. its dialkyl esters, and ethylene glycol, preferably ethanediol.

The present invention also provides compositions comprising polyethylene terephthalate and at least one monomeric carbodiimide of the formula (I) which is purified by means of recrystallization in solvent.

In relation to production of the composition made of polyethylene terephthalate (PET) and of the monomeric carbodiimide of the formula (I) in assemblies for solids metering and mixing, reference is made to the statements above.

During the recrystallization, it is preferable that the carbodiimide is dissolved in at least one solvent at temperatures of 40-80° C., particularly preferably at 50-60° C., and stirred. The mixture is then cooled, with stirring, preferably to 10-25° C., particularly preferably to 15-20° C. The resultant crystals are then isolated by suction-filtration, or separated from the mother liquor. Filter presses, centrifuges, suction-filter funnels or pressure-filter funnels, for example, can be used for this purpose. The solid is then either dried in a drier—for example a paddle drier or drying oven—preferably under reduced pressure, and packed as solid, or charged to a stirred tank, preferably at 50-100° C., freed from residual solvent by distillation, and drawn off as liquid.

Suitable solvents used are preferably alcohols, ketones, nitriles, ethers or esters. Particular preference is given to alcohols from the group of the aliphatic monoalcohols, a preferred example being methanol, ethanol or isopropanol. In another preferred embodiment of the invention, mixtures of various solvents, preferably alcohols, are used.

Particular preference is given here to mixtures of methanol with ethanol in a ratio of 1:3 to 3:1, preferably 1:2 to 2:1, particularly preferably 1:1.

The present invention further provides the use of the compositions of the invention for hydrolysis-resistant mono- and multifilaments made of PET, fibres, films or injection mouldings.

The scope of the invention encompasses all possible combinations of the moiety definitions, indices, parameters and explanations mentioned in general terms or in preferred ranges, above and hereinafter, i.e. including any desired combination involving the respective ranges and preferred ranges.

The examples below serve for explanation of the invention, without any resultant limiting effect.

### EXAMPLES

1) Specimen B: a monomeric carbodiimide with about 8.7% by weight NCN content based on 2,4,6-triisopropylphenyl isocyanate, corresponding to the formula (I)

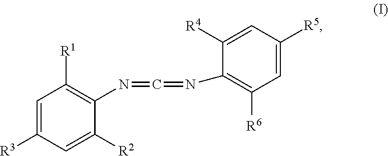

where R¹ to R⁶ are isopropyl, with 3000 ppm content of urea compounds of the formula (II) and formula (III).
2) Specimen C: a monomeric carbodiimide with about 8.7% by weight NCN content based on 2,4,6-triisopropylphenyl isocyanate, corresponding to the formula (I)

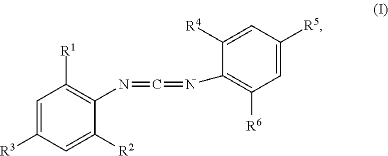

where R¹, R², R⁴ and R⁶ are isopropyl, with <100 ppm content of urea compounds of the formula (II) and formula (III).
3) Polyethylene terephthalate (PET) obtainable as NOVAPET SPRIT H11 from Novapet S.A: with intrinsic viscosity about 0.8 dl/g.

### Production of Specimen B and Specimen C:

400 g of 2,4,6-triisopropylphenyl isocyanate were charged and heated to 140° C. under a current of nitrogen in a scalded nitrogen-filled 500 ml flask with flat ground flange. 400 mg of 1-methylphospholene oxide were added, and then the reaction mixture was heated to 160° C. within a period of 5 hours. The reaction was then continued at 160° C. until NCO content<1% (corresponding to conversion>95%) had been achieved. The crude product thus obtained was:
a) purified by means of distillation at temperature 220° C. under a pressure of 0.1 mbar. The product obtained (specimen B) was a pale yellow liquid with viscosity 700 mPas at 25° C. (see EP 2671912). The content of urea compounds of the formula (II) and formula (III) was 3000 ppm.
b) purified by means of recrystallization in methanol/ethanol mixture (1:1) (see experimental description below). The product obtained (specimen C) was a solid with white to pale yellow crystals and melting point about 50° C. (DSC peak maximum). The content of urea compounds of the formula (II) and formula (III) was <100 ppm.

### Recrystallization (Specimen C)

After carbodiimidation, specimen C was dissolved in ethanol and methanol in the ratio 1:1 in a glass beaker. The mixture was then stirred at 50° C. for 15 min. It was then cooled, with continuous stirring, to a temperature between 18 and 20° C., and again stirred at 18-20° C. for 15 minutes. The resultant crystals were then isolated by suction filtration by way of a suction funnel and dried at 40° C. and 10 mbar in a vacuum drying oven for 8 hours until constant mass was achieved.

### Hydrolysis Resistance in Polyethylene Terephthalate (PET)

For evaluation of the hydrolysis-resistance effect in PET, the stabilizers used in each Example (specimens B and C) were dispersed in the quantities mentioned in Table 1 in PET by means of a ZSK 25 laboratory twin-screw extruder from Werner & Pfleiderer, and the test described below was then carried out. F3 standard test specimens for measurement of ultimate tensile strength were then produced from the resultant granulates in an Arburg Allrounder 320 S 150-500 injection-moulding machine.

For the hydrolysis test, these F3 standard test specimens were stored in water vapour at a temperature of 110° C., and their relative ultimate tensile strength was measured in %.

Table 1 shows the relative tensile strength as percentage, beginning with 100% at day 0:

TABLE 1

| Relative ultimate | Ex. 1 | Ex. 2 (Comp.) | Ex. 3 (Inv.) |
|---|---|---|---|
| tensile strength | (Comp.) | PET, specimen B | PET, specimen C |
| (%) | PET | 0.2% NCN | 0.2% NCN |
| 0 days | 100 | 100 | 100 |
| 1 day | 66 | 85 | 94 |
| 2 days | 5 | 55 | 88 |
| 3 days | 0 | 35 | 70 |
| 4 days | | 3 | 37 |
| 5 days | | 0 | 17 |

Comp. = Comparative example,
Inv. = nventive

The results show that specimen C of the invention has much better hydrolysis resistance than specimen B. Direct comparison of specimen C reveals the importance of the low content of urea contents of the formula (II) and formula (III).

1-18. (canceled)

19. A process for producing a purified monomeric carbodiimide, comprising recrystallizing in a solvent a monomeric carbodiimide of the formula (I) 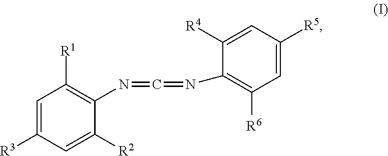
where R¹, R², R⁴ and R⁶ are mutually independently C₃-C₆-alkyl, and R³ and R⁵ are mutually independently C₁-C₃-alkyl,
wherein the solvent is a mixture of methanol and ethanol at a ratio ranging from 1:3 to 3:1, and
wherein the purified monomeric carbodiimide has less than 1000 ppm content of urea compounds of the formulae (II) and (III) 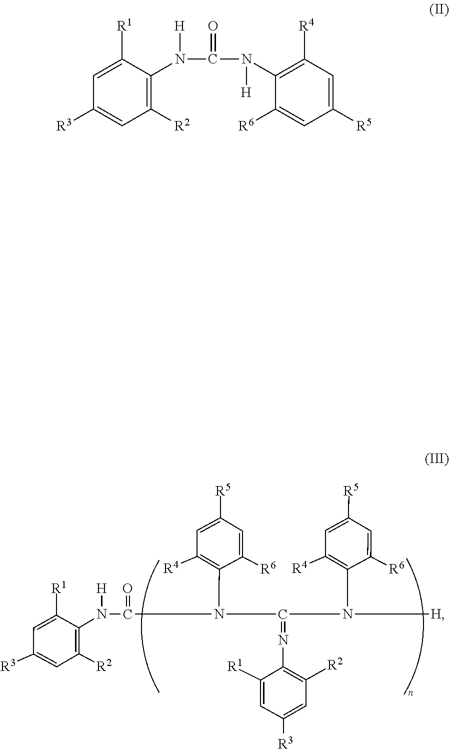
where n is 1 to 100 and R¹, R², R⁴ and R⁶ are mutually independently C₃-C₆-alkyl and R³ and R⁵ are mutually independently C₁-C₃-alkyl.

20. The process of claim 19, wherein the purified monomeric carbodiimide has less than 500 ppm content of the urea compounds of the formulae (II) and (Ill).

21. The process of claim 19, wherein the moieties R¹ to R⁶ are isopropyl.

22. The process of claim 19, further comprising, before recrystallization, producing the monomeric carbodiimide of the formula (I) by the reaction of trisubstituted benzene isocyanates of the formula (IV) 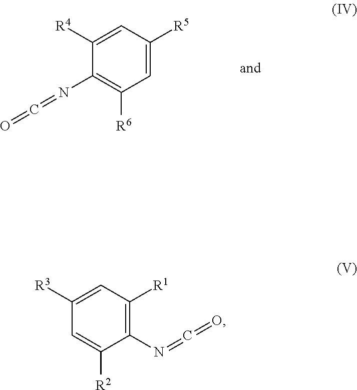
where R¹, R², R⁴ and R⁶ are mutually independently C₃-C₆-alkyl, and R³ and R⁵ are mutually independently C₁-C₃-alkyl, at temperatures of 40° C. to 200° C. in the presence of at least one catalyst and with elimination of carbon dioxide.

23. The process of claim 19, wherein the recrystallization comprises dissolving the monomeric carbodiimide of the formula (I) in the solvent at a temperature ranging from 40° C. to 80° C. to form a recrystallization mixture.

24. The process of claim 23, further comprising cooling the recrystallization mixture to a temperature ranging from 10° C. to 25° C.

25. A process for producing a polyethylene terephthalate (PET) composition, comprising producing a purified monomeric carbodiimide according to the process of claim 1, and mixing the purified monomeric carbodiimide with PET.

26. The process according to claim 25, wherein the purified monomeric carbodiimide is present in the PET composition in an amount ranging from 0.5 to 5% by weight.

27. The process according to claim 25, wherein the purified monomeric carbodiimide is present in the PET composition in an amount ranging from 1.5 to 2.5% by weight.

28. The process according to claim 25, wherein the purified monomeric carbodiimide and PET are mixed in an extruder.
